(19) United States
(12) Patent Application Publication
(10) Pub. No.: US 2011/0006572 A1
(43) Pub. Date: Jan. 13, 2011

(54) Child car seat and elastic crotch belt thereof

(75) Inventor: Guang-Hui Zhao, Taipei (TW)

Correspondence Address: BACON & THOMAS, PLLC, 625 SLATERS LANE, FOURTH FLOOR, ALEXANDRIA, VA, 22314-1176, US

(73) Assignee: Wonderland Nurserygoods Company Limited, Hong Kong (CN)

(21) Appl. No.: 12/801,315

(22) Filed: Jun. 3, 2010

(30) Foreign Application Priority Data
Jul. 13, 2009 (CN) 200910152123.6

(51) Int. Cl. B60N 2/26

(52) U.S. Cl. 297/256.15

(57) ABSTRACT

A crotch belt assembly for a child car seat comprising a safety belt system and a seat body is provided. The safety belt system is composed of shoulder harnesses provided with a buckle and the crotch belt assembly. The crotch belt assembly comprises a crotch belt set, a crotch protection pad shielding the crotch belt set, and an elastic body. One end of the crotch belt set is connected to a buckle body adapted to be locked with the buckle and the other end of the crotch belt set is connected to the seat body. The elastic body is inserted into an accommodating space of the crotch protection pad and is arranged at least partially against the seat body so that the crotch belt assembly, when not in use, is kept in a desired position.

### FIELD OF THE INVENTION

The present invention generally relates to a child car seat. More particularly, the present invention relates to a child car seat and an elastic crotch belt for securing an infant/child on the child car seat.

### BACKGROUND OF THE INVENTION

In consideration of safety when carrying an infant/child in a car, a child car seat is designed to be firmly fixed upon the seat of the car by the car seat belt or other auxiliary means, so that the infant/child can be thoroughly protected from harm during an accident.

When seated in such a child car seat, the infant/child is secured by a safety belt system, such as those disclosed by U.S. Pat. No. 6,419,316 and U.S. Pat. No. 6,659,564. The safety belt system is generally comprised of adjustable shoulder harnesses, a crotch belt and a buckle connected to the crotch belt, wherein the buckle is adapted to be locked with the shoulder harnesses so that thorough protection is provided. However, there are still some inconveniences when using the conventional safety belt system. For example, when not in use, the crotch belt connected with the buckle will naturally fall upon center of the seat base due to the weight of the buckle. As such, it is necessary to remove the crotch belt at first so that the infant/child can be successfully put into position. This removing action is annoying to a caregiver when both hands of the caregiver are busy holding the infant/child.

### SUMMARY OF THE INVENTION

In view of the above inconvenience, a purpose of the present invention is to provide a safety belt system which relieves the caregiver of the annoying action of removing the crotch at first, thereby improving comfort and convenience of the child car seat. The safety belt system according to the present invention is provided so that, in an unlocked (unused) state, a crotch belt is adapted to automatically return to a proper position that won't hamper usage of the child car seat.

According to an aspect of the present invention, a crotch belt assembly for a child car seat comprising a safety belt system and a seat body is provided, the safety belt system being composed of shoulder harnesses provided with a buckle and the crotch belt assembly, the crotch belt assembly comprising a crotch belt set, a crotch protection pad shielding the crotch belt set, and an elastic body, wherein one end of the crotch belt set is connected to a buckle body adapted to be locked with the buckle and the other end of the crotch belt set is connected to the seat body; and wherein the elastic body is inserted into an accommodating space of the crotch protection pad and is arranged at least partially against the seat body so that the crotch belt assembly, when not in use, is kept in a desired position.

According to the above aspect, in the crotch belt assembly of the present invention, area of one end of the crotch protection pad is larger than that of the buckle body.

According to the above aspect, in the crotch belt assembly of the present invention, the crotch protection pad is combined with the crotch belt set by hook-and-loop fasteners.

According to the above aspect, in the crotch belt assembly of the present invention, the crotch protection pad is combined with the crotch belt set by sewing.

According to another aspect of the present invention, a child car seat comprising: a seat body and a safety belt system arranged on the seat body is provided, characterized in that the safety belt system is composed of shoulder harnesses provided with a buckle and a crotch belt assembly, the crotch belt assembly comprising a crotch belt set, a crotch protection pad shielding the crotch belt set, and an elastic body, wherein one end of the crotch belt set is connected to a buckle body adapted to be locked with the buckle and the other end of the crotch belt set is connected to the seat body; and wherein the elastic body is inserted into an accommodating space of the crotch protection pad and is arranged at least partially against the seat body so that the crotch belt assembly, when not in use, is kept in a desired position.

The present invention has achieved an advantageous effect of automatically positioning the crotch belt in a desired position so that it is not necessary to remove the crotch belt before putting an infant/child in a child car seat. Besides, the crotch protection pad operates as an effective shield for the replaceable elastic body.

### BRIEF DESCRIPTION OF THE DRAWINGS

Embodiments of the present invention will now be described by way of examples with reference to the accompanying drawings, wherein like parts are provided with corresponding reference numerals, in which:

FIG. 1A is a front view showing a crotch belt assembly according to an embodiment of the present invention;

FIG. 1B is a side view showing the crotch belt assembly according to an embodiment of the present invention;

FIG. 2 shows the crotch belt assembly according to an embodiment of the present invention before combination;

FIGS. 3A-3C are schematic diagrams illustrating insertion of the elastic body into the crotch protection pad;

FIG. 4 shows a crotch belt assembly according to another embodiment of the present invention;

FIG. 5A shows a child car seat incorporating the crotch belt assembly according to the present invention, wherein the crotch belt assembly is in a locked (in-use) state;

FIG. 5B shows the child car seat incorporating the crotch belt assembly according to the present invention, wherein the crotch belt assembly is in an unlocked (unused) state; and

FIGS. 6A and 6B schematically show an embodiment in which a pocket portion of the crotch protection pad is not inserted into the fabric and an embodiment in which the pocket portion of the crotch protection pad is partially inserted into the fabric, respectively.

### DETAILED DESCRIPTION OF THE PREFERRED EMBODIMENT

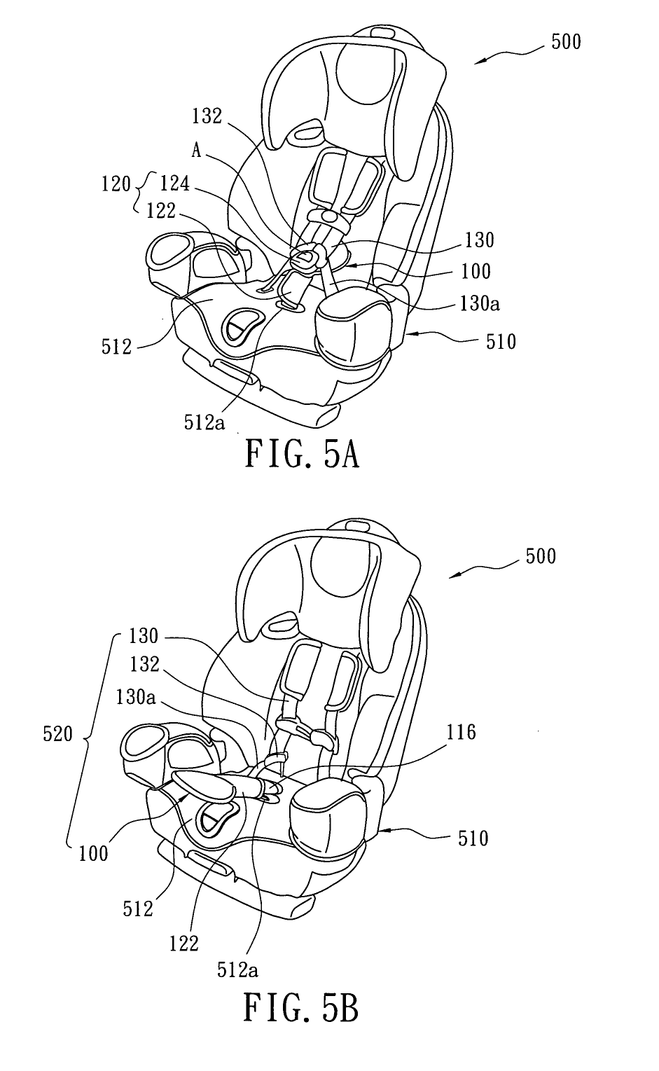

Refer firstly to FIGS. 5A and 5B, which illustrate a crotch belt assembly 100 in a in-use state and an unused state, respectively. In FIG. 5B, a child car seat 500 comprises a seat body 510 and a safety belt system 520 composed of shoulder harnesses 130 and the crotch belt assembly 100.

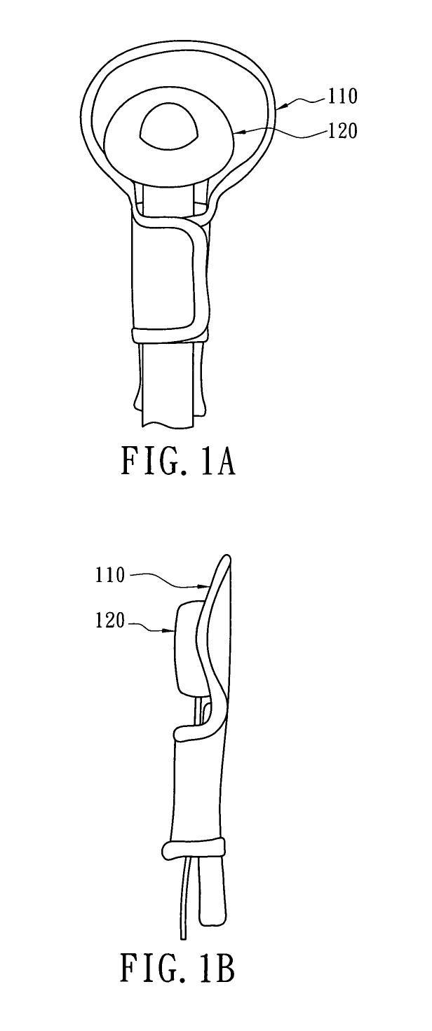

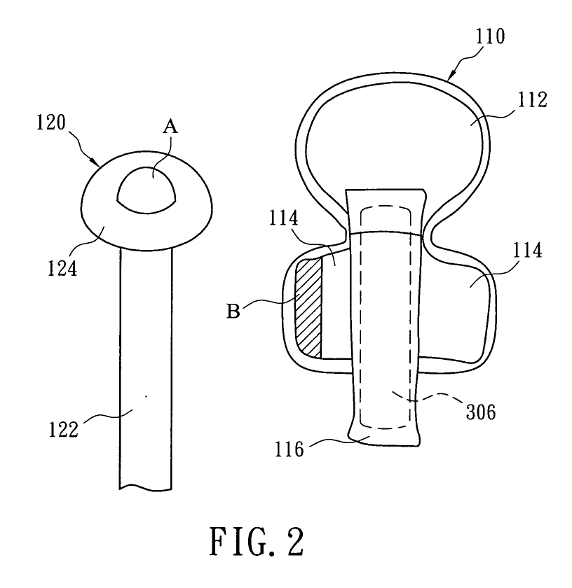

Referring to FIGS. 1 and 2, the crotch belt assembly 100 according to an embodiment of the present invention is shown, wherein FIG. 1A shows a front view of the crotch belt assembly 100 after combination; FIG. 1B shows a side view of the crotch belt assembly 100 after combination; and FIG. 2 shows the crotch belt assembly 100 before combination. As shown in FIG. 2, the crotch belt assembly 100 is composed of a crotch belt set 120, a crotch protection pad 110, and an elastic body 306.

Referring to FIG. 2, the crotch belt set 120 includes a crotch belt 122 and a buckle body 124. One end of the crotch belt 122 is connected to the buckle body 124, and the other end thereof is connected to the seat body 510 shown in FIGS. 5A and 5B. As shown in FIGS. 5A and 5B, the seat body 510 includes a seat base 512, wherein the crotch belt 122 penetrates through an opening 512a on the seat base 512. The shoulder harnesses 130 are attached to the seat body 510 with the other ends connected to a male buckle 132. The male buckle 132 is adapted to be locked with the buckle body 124 so as to secure the infant/child on the child car seat 500. Generally, the buckle body 124 is provided with a button A so that the male buckle 132 on the shoulder harnesses 130 could be promptly released from the buckle body 124 by pressing the button A. Please refer to the locked state as shown in FIG. 5A and the unlocked state as shown in FIG. 5B. Preferably, the shoulder harnesses 130 pass through the male buckle 132 before being fastened upon the seat base 512. In the present embodiment, the male buckle 132 is slidable on the shoulder harnesses 130, and the portions of the shoulder harnesses 130 below the male buckle 132 are utilized as waist belt 130a, as shown in FIGS. 5A and 5B.

As shown in FIG. 2, the crotch protection pad 110 includes the following three parts: a protection portion 112, side wings 114 and a pocket portion 116. The protection portion 112 is manufactured by a soft material, and usually has an area larger than that of the buckle body 124 so that it could be used as a cushion when the male buckle 132 is locked with the buckle body 124, thereby preventing the seated infant/child from uncomfortable feeling due to the direct contact between its crotch and the buckle body 124. The side wings 114 are used to cover and hold the crotch belt set 120 so that the crotch protection pad 110 and the crotch belt set 120 are firmly combined together. In the embodiment shown in FIG. 2, a portion of the side wings 114 is provided with hook-and-loop fasteners B to maintain a state of firmly holding the crotch belt set 120, as shown in FIG. 1A. The pocket portion 116 is used to contain the elastic body 306, which is employed to achieve the effect of causing the crotch belt assembly 100 to return to the desired position.

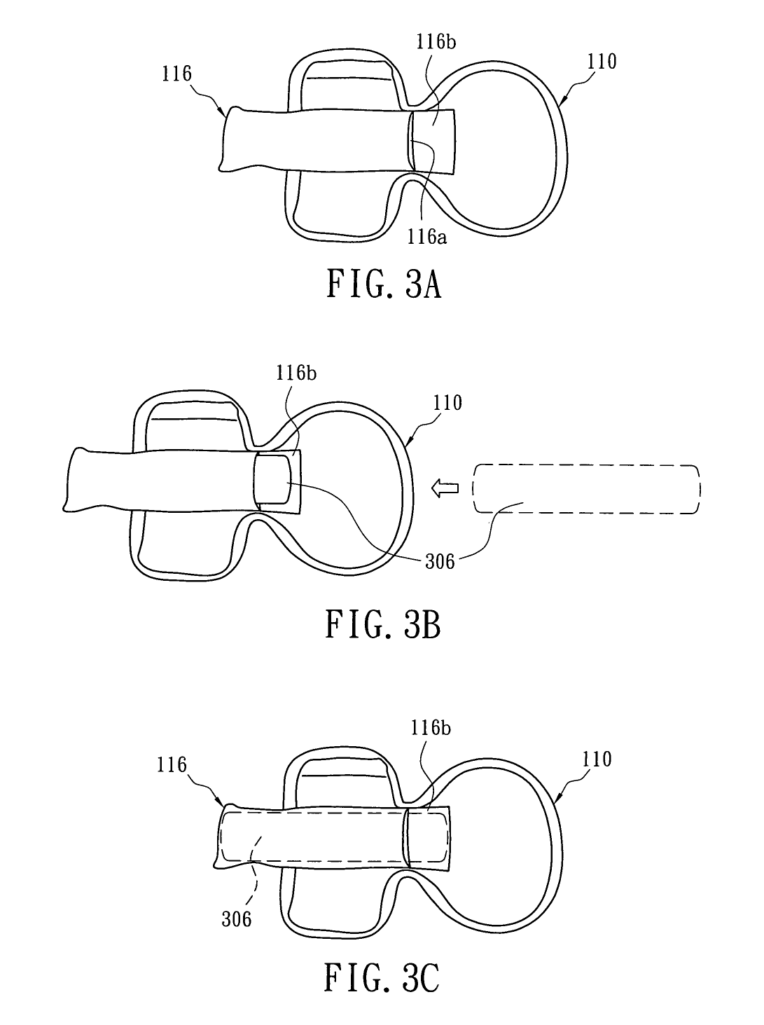

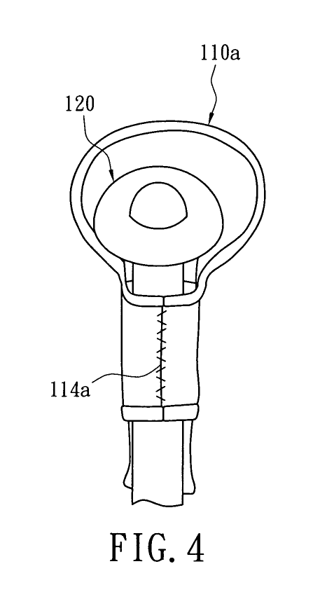

Next, the combination of the crotch protection pad 110 and the elastic body 306 according to an embodiment of the invention is explained by referring to FIGS. 3A-3C. As shown in FIG. 3A, the pocket portion 116 includes an opening 116a and an upper lid 116b. When combining, the elastic body 306 is inserted into the inner space of the pocket portion 116 from the opening 116a, as shown in FIG. 3B. As the elastic body 306 is completely inserted, the upper lid 116b is used to cover the opening 116a so that the elastic body 306 will not be exposed or dropped out of the pocket portion 116, as shown in FIG. 3C. The elastic body 306 used here is formed by any object with elasticity, as long as the elasticity of the object is sufficient to force the crotch belt assembly 100 to automatically return to desired position in an unlocked (unused) state. Then, as mentioned earlier, the side wings 114 are used to cover and hold the crotch belt set 120 by the hook-and-loop fasteners B, so that the crotch protection pad 110 and the crotch belt set 120 are firmly combined together, as shown in FIGS. 1A and 1B. In addition to the hook-and-loop fasteners, other means in this technical field could be employed to combine the crotch protection pad 110 with the crotch belt set 120. For example, FIG. 4 shows another embodiment of combining the crotch protection pad 110a with the crotch belt set 120 by sewing. After combination, as shown in FIG. 4, the combining portion 114a of the side wings 114 and the elastic body 306 are positioned on opposite sides of the crotch belt set 120.

Next, as shown in FIG. 5A, in order to provide thorough protection for the infant/child seated on the child car seat 500, the male buckle 132 is locked with the buckle body 124 so that the crotch belt set 120 and the shoulder harnesses 130 are fastened together. To unfasten the safety belt system 520, one can simply press the button A so that the male buckle 132 on the shoulder harnesses 130 will be promptly released from the buckle body 124 on the crotch belt set 120. At this moment, due to the elastic effect of the elastic body 306, the crotch belt assembly 100 will automatically return to and maintain at its desired position in the unused state, as shown in FIG. 5B. As such, the infant/child seated on the child car seat 500 could easily leave the child car seat 500 without any obstacle. Since the crotch belt assembly 100 is kept at the position as shown in FIG. 5B, it is not necessary to remove the crotch belt set 120 from center of the seat body 510 prior to using the child car seat 500. After putting the infant on the child car seat 500, a caregiver can pull up the crotch belt set 120 and then easily lock the buckle body 124 with the male buckle 132 on the shoulder harnesses 130.

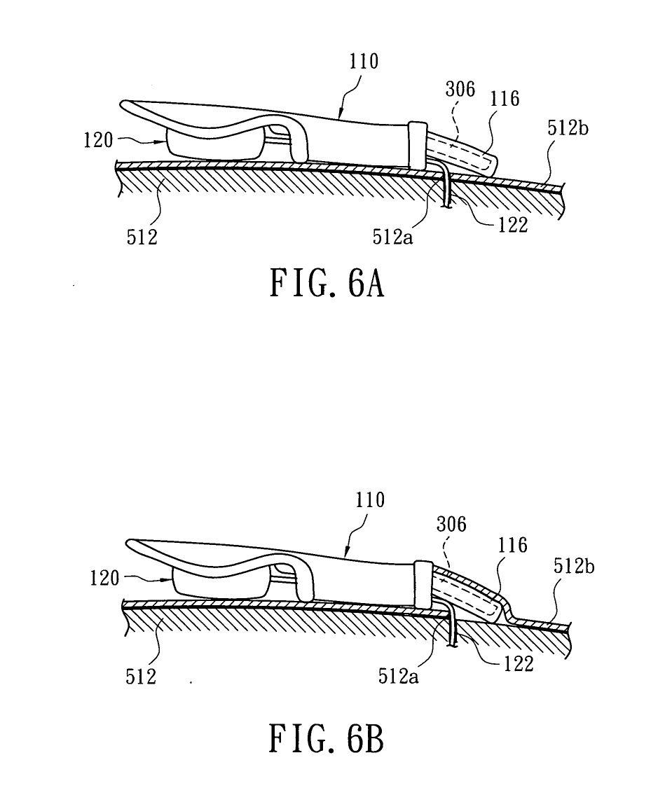

Referring to FIGS. 6A and 6B, the operation of the elastic body 306 is explained. It should be noted that a dotted line is utilized to express the elastic body 306 contained by the pocket portion 116. Besides, the surface of the seat base 512 is covered by a fabric 512b. As shown in FIG. 6A, the elastic body 306 is inserted into the inner space of the pocket portion 116, and the end of the pocket portion 116 extends beyond the opening 512a so that at least a part of the elastic body 306 is positioned against the fabric 512b, thereby ensuring that the elastic body 306 is adapted to facilitate keeping the crotch belt assembly 100 in the desired position. Preferably, as shown in FIG. 6B, the pocket portion 116 containing the elastic body 306 is also covered by the fabric 512b to further prevent the infant/child from feeling uncomfortable.

Moreover, the invention is not limited to the above features. For example, since the elastic body 306 is removable from the pocket portion 116 of the crotch protection pad 110, it can be replaced in case elastic fatigue occurs. Besides, the crotch protection pad 110 is adapted to protect the elastic body 306 from stained, damaged or accidentally falling off.

The child car seat and the elastic crotch belt thereof according to the invention have improved comfort and convenience by relieving the caregiver of the annoying action of removing the crotch belt prior to putting the infant/child on the child car seat.

While the present invention has been described with reference to the preferred embodiments, it will be understood by those skilled in the art that various changes may be made and equivalents may be substituted for elements thereof without departing from the scope of the invention. Therefore, it is intended that the invention will include all embodiments falling within the scope of the appended claims.

1. A crotch belt assembly for a child car seat comprising a safety belt system and a seat body, the safety belt system being composed of shoulder harnesses provided with a buckle and the crotch belt assembly, the crotch belt assembly comprising:
a crotch belt set, with one end connected to a buckle body and the other end connected to the seat body, wherein the buckle body is adapted to be locked with the buckle;
a crotch protection pad for shielding the crotch belt set; and
an elastic body inserted into an accommodating space of the crotch protection pad,
wherein the elastic body is arranged at least partially against the seat body so that the crotch belt assembly, when not in use, is kept in a desired position.

2. The crotch belt assembly of claim 1, wherein area of one end of the crotch protection pad is larger than that of the buckle body.

3. The crotch belt assembly of claim 1, wherein the crotch protection pad includes two side wings for covering and holding the crotch belt set.

4. The crotch belt assembly of claim 3, wherein the crotch protection pad is combined with the crotch belt set by hook-and-loop fasteners or by sewing.

5. The crotch belt assembly of claim 3, wherein after combination, a combining portion of the side wings and the elastic body are positioned on opposite sides of the crotch belt set.

6. The crotch belt assembly of claim 1, wherein the crotch protection pad includes a pocket portion with an opening, and the accommodating space is arranged inside the pocket portion.

7. The crotch belt assembly of claim 6, wherein the crotch protection pad includes an upper lid for covering the opening.

8. A child car seat comprising:
a seat body; and
a safety belt system arranged on the seat body, characterized in that the safety belt system is composed of shoulder harnesses provided with a buckle and a crotch belt assembly, the crotch belt assembly comprising:
a crotch belt set, with one end connected to a buckle body and the other end connected to the seat body, wherein the buckle body is adapted to be locked with the buckle;
a crotch protection pad for shielding the crotch belt set; and
an elastic body inserted into an accommodating space of the crotch protection pad,
wherein the elastic body is arranged at least partially against the seat body so that the crotch belt assembly, when not in use, is kept in a desired position.

9. The child car seat of claim 8, wherein area of one end of the crotch protection pad is larger than that of the buckle body.

10. The child car seat of claim 8, wherein the crotch protection pad includes two side wings for covering and holding the crotch belt set.

11. The child car seat of claim 10, wherein the crotch protection pad is combined with the crotch belt set by hook-and-loop fasteners or by sewing.

12. The child car seat of claim 10, wherein after combination, a combining portion of the side wings and the elastic body are positioned on opposite sides of the crotch belt set.

13. The child car seat of claim 8, wherein the crotch protection pad includes a pocket portion with an opening, and the accommodating space is arranged inside the pocket portion.

14. The child car seat of claim 13, wherein the crotch protection pad includes an upper lid for covering the opening.

15. The child car seat of claim 8, wherein both ends of the shoulder harnesses are fixed on the seat body, and the buckle is slidable on the shoulder harnesses.

16. The child car seat of claim 8, wherein the seat body includes a fabric, and both the crotch protection pad and the elastic body are partially covered by the fabric.
